(19) United States
(12) Patent Application Publication
(10) Pub. No.: US 2005/0144309 A1
(43) Pub. Date: Jun. 30, 2005

(54) Systems and methods for controlling congestion using a time-stamp

(75) Inventor: David W. Gish, Riverdale, NJ (US)

Correspondence Address: JUNG-HUA KUO;C/O PORTFOLIOIP, P. O. BOX 52050, MINNEAPOLIS, MN, 55402, US

(73) Assignee: Intel Corporation, A DELAWARE CORPORATION, Santa Clara, CA (US)

(21) Appl. No.: 10/737,994

(22) Filed: Dec. 16, 2003

(51) Int. Cl. G06F 15/16

(52) U.S. Cl. 709/233

(57) ABSTRACT

Systems and methods are disclosed for managing congestion in a system or network fabric using a time-stamp. In one embodiment, a time-stamp is applied to packets at a first node. The packets are then transmitted to a second node. When a packet reaches the second node, the packet's time-stamp is used to calculate the amount of time taken for the packet to reach the second node. If this amount of time is greater than a predefined amount, a notification is sent to the first node. In response to receiving the notification, the first node reduces the rate at which at least some additional packets are transmitted to the second node.

### BACKGROUND

Advances in networking technology have led to the widespread use of computer networks for a variety of applications, such as sending and receiving electronic mail, browsing Internet web pages, exchanging business data, and the like. As the use of computer networks becomes increasingly widespread, the technology upon which they are based has become increasingly complex as well.

Computer networks are used to transport information between computer systems. Data is typically sent over a network in small packages called “packets.” The packets include information specifying their destination, and this information is used by intermediate network nodes to route the packets appropriately. These intermediate network nodes (e.g., routers, switches, and the like) are often complex computer systems in their own right, and may include a variety of specialized hardware and software components. Computer systems and sub-networks are connected using a variety of physical media (e.g., copper wire, fiber optic cable, etc.) and a variety of different protocols (e.g., synchronous optical network (SONET), asynchronous transfer mode (ATM), transmission control protocol (TCP), etc.). This complex fabric of interconnected computer systems and networks is somewhat analogous to the system of highways, streets, traffic lights, and toll booths upon which automobile traffic travels.

Today, networking technology enables more data to be transported at greater speeds and over greater distances than ever before. As network use proliferates, and as greater demands are placed on the network infrastructure, the ability to control the behavior and performance of networks, and the components that contribute to their operation, has also become increasingly important. For example, techniques are needed to combat congestion (e.g., “traffic jams”), detect faulty behavior, and/or the like.

### BRIEF DESCRIPTION OF THE DRAWINGS

Reference will be made to the following drawings, in which:

FIG. 1 is a diagram of an illustrative system fabric.

FIG. 2 illustrates congestion on a system fabric.

FIG. 3 illustrates the use of a time-stamp-based congestion management mechanism.

FIG. 4 illustrates a method for managing congestion on a system fabric or network.

### DESCRIPTION OF SPECIFIC EMBODIMENTS

Systems and methods are disclosed for providing a common time base in a system fabric, and for using the time base to manage congestion. It should be appreciated that these systems and methods can be implemented in numerous ways, several examples of which are described below. The following description is presented to enable any person skilled in the art to make and use the inventive body of work. The general principles defined herein may be applied to other embodiments and applications. Descriptions of specific embodiments and applications are thus provided only as examples, and various modifications will be readily apparent to those skilled in the art. Accordingly, the following description is to be accorded the widest scope, encompassing numerous alternatives, modifications, and equivalents. For purposes of clarity, technical material that is known in the art has not been described in detail so as not to unnecessarily obscure the inventive body of work.

A system fabric comprises a set of input ports, a set of output ports, and a mechanism for establishing logical connections therebetween. For example, a system fabric may receive data from an external network (e.g., a local area network or wide area network), process the data, and send it over the external network to another networked system and/or system fabric. A system fabric is often (but not necessarily) locally administered, with well-defined software (e.g., the software of the system administrator) running on its component parts. Examples of system fabrics, or systems that contain them, include, without limitation, routers, media gateways, servers, radio network controllers, and the like.

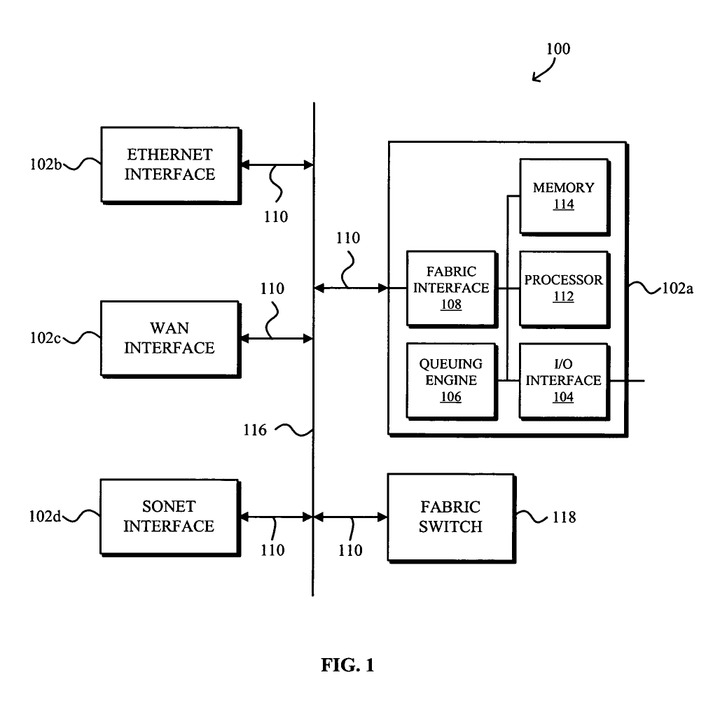

An illustrative system fabric 100 is shown in FIG. 1. As shown in FIG. 1, the fabric 100 includes a variety of nodes 102 (often called “boards” or “blades”) that may, for example, serve as interfaces between the fabric and other networks and/or network nodes. For example, boards 102 may include an Ethernet interface 102b, a wide area network (WAN) interface 102c, a synchronous optical network (SONET) interface 102d, and/or the like. As shown in more detail in connection with board 102a, each board 102 may include an input/output interface 104 for communicating with external networks and/or nodes, a queuing engine 106 for routing incoming or outgoing network traffic to the appropriate board 102 or external destination, and a fabric interface 108 for communicating with the other components of the fabric over logical and/or physical links 110. Boards 102 may also include a processor 112 (such as a network processor) and memory 114 (such as a random access memory (RAM), read only memory (ROM), and/or other suitable computer-readable media) for storing programs that control the board's operation. Boards 102 may be plugged into a backplane 116 that has one or more associated fabric switches 118. Fabric switches 118 manage the flow of traffic over the matrix of possible interconnections between boards 102.

As indicated above, the basic architecture shown in FIG. 1 is found in a variety of network components (and groups of components), such as routers or groups of routers, media gateways, firewalls, wireless radio network controllers, and a wide variety of other devices or groups of devices. It should be appreciated, however, that FIG. 1 is provided for purposes of illustration, and not limitation, and that the systems and methods described herein can be practiced with devices and architectures that lack some of the components and features shown in FIG. 1, and/or that have other components or features that are not shown.

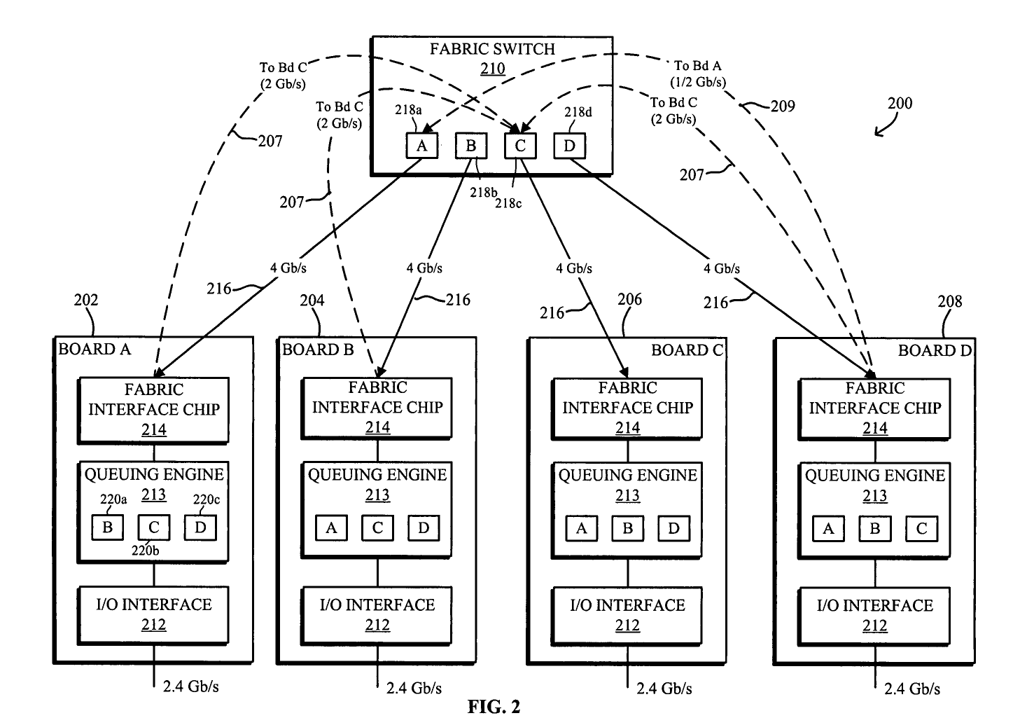

FIG. 2 shows a system fabric 200 that includes four boards 202, 204, 206, 208, and a switch 210. In this example, boards 202, 204, 206, 208 each include an input/output interface 212 for receiving packets from outside the fabric 200, and for sending packets from the fabric 200 to external fabrics or devices. In the example shown in FIG. 2, each board is able to send and receive packets from outside the fabric at 2.4 gigabits per second (Gb/s) (e.g., as in SONET OC 48). Each board also includes a fabric interface 214 for communicating with the other boards in the fabric 200 via switch 210. In the example shown in FIG. 2, the boards are able to communicate with each other using 4 Gb/s links 216. Fabric switch 210 is responsible for receiving traffic from boards 202, 204, 206, and 208 and directing this traffic to the appropriate destination board. To that end, fabric switch 210 may have one or more queues 218 for managing the traffic flow to each board (e.g., a queue 218 for each board and/or combination of boards).

In the example shown in FIG. 2, boards 202, 204, and 208 are each sending traffic at 2 Gb/s to board 206 (shown with dashed lines 207). However, since each board's fabric link is only 4 Gb/s, the fabric switch's output queue 218c for board 206 will back up. If the total of 6 Gb/s going to board 206 is not reduced, the output queue 218c for board 206 will overflow. In addition, because board 206 only has a 2.4 Gb/s egress, its egress queue will back up as well.

One way to reduce the 6 Gb/s flow to 4 Gb/s or less is for fabric switch 210 to throttle the incoming fabric links using some form of link-layer flow control. For example, fabric switch 210 could send Ethernet pause packets to boards 202, 204, and 208, causing them to temporarily cease (or slow) transmission. However, this method may unnecessarily throttle data that is not contributing to the congestion. For example, as shown in FIG. 2, board 208 also has some data going to board 202 at ½ Gb/s (shown with dashed line 209). Since there is no backup on the fabric switch's output queue 218a for board 202, throttling the whole incoming fabric link from board 208 will slow this data for no reason.

A better way to solve the problem is through some form of congestion management. Each board's queuing engine 213 (which may be hardware and/or software) implements a separate queue for each destination board. For example, board 202 might have destination output queues 220a, 220b, and 220c for boards 204, 206, and 208, respectively.

When switch 210 detects that one of its output queues is backing up, it sends a control message back to one or more of the source boards. In the example shown in FIG. 2, a control message would be sent to the queuing engines of boards 202, 204, and 208, telling them to slow or suspend transmissions to board 206. With a congestion management-based solution, the flow of data 209 from board 208 to board 202 is not affected when the fabric switch's output queue for board 206 backs up. This, in turn, allows fabric switch 210 to use the fabric's bandwidth more effectively.

Thus, in general terms, congestion management regulates the traffic along specific paths (e.g., from specific sources to specific destinations), whereas flow control regulates all traffic from a given source, regardless of the destination. It will be appreciated, however, that in some applications a mixture of both approaches might be used, and that, as a result, when an application is said to use “congestion management” techniques, it is not intended to imply that the application may not also use some flow control techniques as well.

As the number of nodes on a fabric increases, the potential for congestion also increases, since it is more likely that multiple sources will effectively gang up on one destination. As described in more detail below, in one embodiment a congestion management technique is provided that makes use of time-stamping. Frames or packets within a fabric are time-stamped at their source. Upon receipt at a destination node, a determination can be made as to the length of time it took the frame to cross the fabric (e.g., the time-stamp can be compared to the current time). Relatively congested paths can thus be identified, and notification can be sent back to the relevant sources, instructing them to slow or temporarily suspend transmission over the identified paths. In one embodiment, these notification messages are sent at a relatively high priority level, thereby minimizing the amount of time needed for the sources to receive the notification. As described below, these techniques can also be advantageously used in conjunction with rate-based shaping, and/or in systems that employ protocols in which some packets are dropped (e.g., systems that use Random Early Detection).

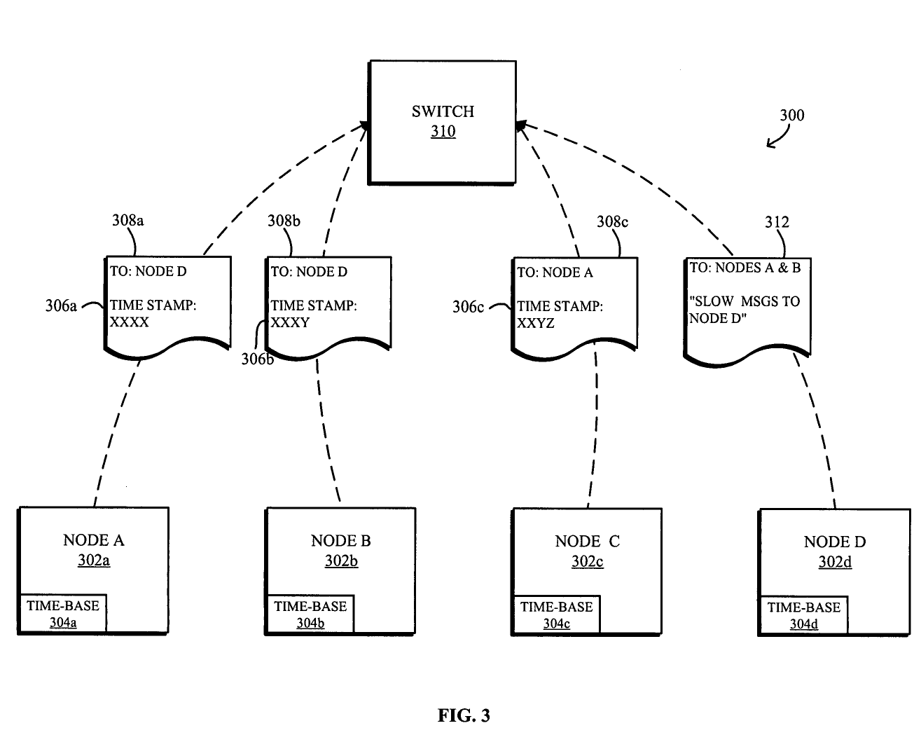

FIG. 3 shows the use of a congestion management technique such as that described above. A common time base 304 is implemented across the nodes 302 of a system 300 (e.g., a system fabric such as that shown in FIG. 2, or a network). This may be accomplished using, e.g., the Network Timing Protocol (NTP) or any other suitable technique (e.g., the IEEE 1588 clock synchronization standard, IEEE std. 1588-2002, published Nov. 8, 2002). Once the common time base is synchronized within the endpoint nodes 302, the nodes append a time-stamp 306 to outgoing packets 308. In one embodiment, the time-stamp 306 comprises a 16-bit value, although it will be appreciated that a time-stamp of any suitable size could be used. The time-stamp is derived from the time-base 304 maintained at the source node 302, and in one embodiment corresponds to the moment when the packet is actually sent to the fabric (or network) from the source node (e.g., by the output scheduler), as opposed to the time that the packet was put on the source node's output queue.

In the context of a system fabric, when the time-stamped packet 308 is received at a destination node 302, the amount of time that the packet took to traverse the fabric is calculated (e.g., by subtracting the time indicated by the time-stamp from the current time). In this way, paths of congestion can be detected. That is, a determination can be made as to which queues within the switch 310 are backing up by examining the length of time it takes packets passing through those queues to cross the fabric. This, in turn can be used to identify specific paths of congestion.

An advantage of this approach is that it can be handled by software running on the endpoint nodes 302, and does not require special hardware support in the fabric switch device 310. Thus, for example, this congestion detection mechanism can be used with relatively inexpensive Ethernet switch devices.

Once congestion is detected, a message 312 is sent from the destination node (e.g., node 302d) back to the source node(s) that are causing the congestion (e.g., nodes 302a and 302b), with instructions to slow down traffic along the affected path (e.g., to slow the rate at which additional packets are transmitted from the source(s) to the destination). This messaging process is similar to backward explicit congestion notification (BECN), and for present purposes the message 312 that is sent back to the source node(s) will be referred to as a BECN. The source responds to the BECN by slowing or momentarily stopping traffic along the specified path until congestion is alleviated.

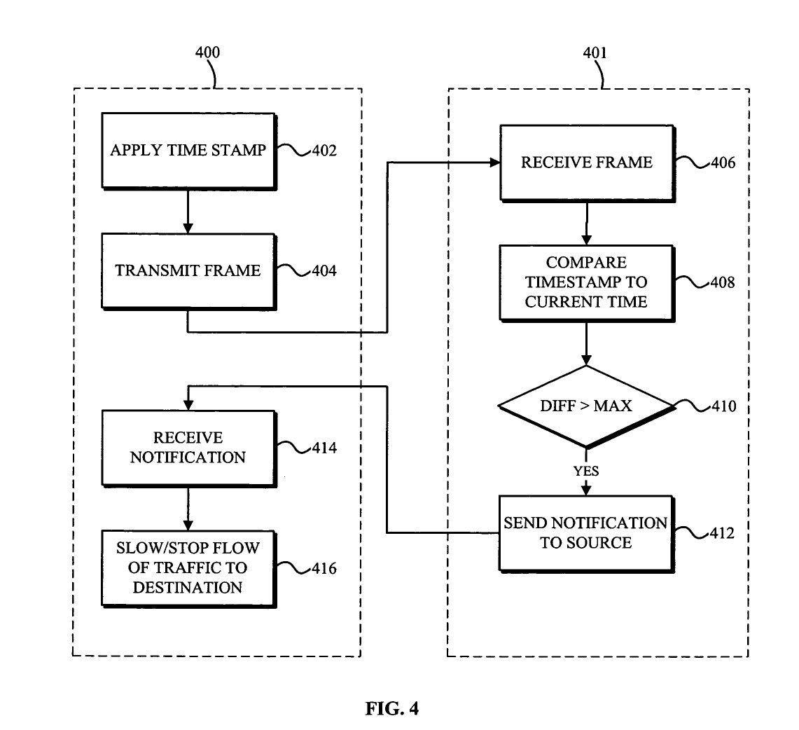

A congestion management technique such as that described above is illustrated in FIG. 4. As shown in FIG. 4, a source node 400 applies a time-stamp to an outgoing packet or frame (block 402), which it then transmits to destination node 401 (block 404). Destination node 401 receives the packet (block 406) and evaluates the packet's time stamp by comparing the packet's time-stamp to the time indicated by the destination node's time base (block 408). If the difference between the packet's time-stamp and the destination node's time base exceeds a predefined amount (i.e., a “Yes” exit from block 410), then the destination node sends a notification (BECN) to the packet's source (block 412). When the source node 400 receives the BECN (block 414), it temporarily slows or stops further traffic to destination node 401 (block 416). In one embodiment, the actions shown in FIG. 4 are implemented in software on the source and destination nodes (and in one embodiment, each node includes software to perform the actions of both the source and destination nodes, such that each node can play either role); it will be appreciated, however, that in other embodiments, a combination of software and special-purpose hardware could be used.

In one embodiment the BECN is sent at a relatively high priority level. For example, the BECN could be sent at a priority that is higher than the priority of the forward-moving system fabric frames that encountered the congestion, thus decreasing the likelihood that the BECN will encounter congestion, and thus increasing the likelihood that the source nodes will receive the notification in time to avert undesirable consequences, such as overflow of the fabric switch's output queue.

The different levels of priority can be implemented using a class of service (COS) queuing mechanism, in which each class of service is separately queued. This can help avoid congestion at the higher priority classes of service. Most Ethernet switches implement some sort of class of service based queuing. In some embodiments, the different classes of service may employ different congestion management schemes.

Examples of different classes of service might include real-time traffic (e.g. voice, video, and the like), control traffic, managed traffic (e.g. service-level agreements), and best effort traffic (e.g. normal Internet packets), although any suitable classification system could be used. Additional information about these illustrative classes is provided below.

Real-time traffic typically has relatively strict, low latency requirements, and uses relatively low bit rates (e.g., it is generally relatively rare that a system will become saturated with real-time traffic). Real-time traffic will also generally have fairly constant and/or predictable bit rates. As a result, real time traffic is typically assigned a relatively high (often the highest) priority class of service.

Control traffic will, like real-time traffic, typically have relatively low latency requirements. Control traffic typically uses low to moderate bit rates (e.g., control traffic usually does not consume the majority of the system's resources), contains bursty traffic (e.g., traffic bursts are common, during which the bit rate may vary dramatically), and may require guaranteed delivery (e.g., reliability protocols are often used). As a result, control traffic, like real-time traffic, will generally be assigned a relatively high (if not the highest) priority class of service.

Managed traffic is often associated with service level agreements that guarantee a certain minimum amount of bandwidth. Managed traffic generally has relatively low to medium latency requirements, has moderate to high average bit rates, and contains bursty traffic. As a result, managed traffic is generally assigned a medium priority class of service.

Best effort traffic generally comprises the bulk of network traffic that does not fall within one of the classes described above. Best effort traffic can generally tolerate relatively high latency, has moderate to high average bit rates, and contains bursty traffic. Best effort traffic is typically assigned the lowest priority class of service.

As previously indicated, in one embodiment a time-stamp-based congestion management technique is used in conjunction with rate-based shaping at the source nodes. Rate-based shaping is used to help avoid congestion by limiting the amount of traffic that can go over a given path to a specified rate. This is somewhat similar to the way a traffic light on a freeway entrance ramp limits the rate at which traffic can enter the freeway.

One way to implement rate-based traffic shaping is with a “token bucket” algorithm. In such an algorithm, a counter is periodically incremented by a specified amount until a predefined ceiling is reached. When a packet is sent to the fabric, the size of the packet is subtracted from the counter. A packet may only be sent if the number of bytes in the packet is less than the value of the counter. Thus, the value of the counter effectively indicates the largest packet (or burst of packets) that the node can send to the fabric.

In one embodiment, it is assumed that the control plane has predetermined a minimum shaping bandwidth for each class of service and path, such that congestion will not occur. This is referred to as the guaranteed minimum bandwidth level of shaping. In other words, the control plane assigns a certain minimum amount of bandwidth to each class of service (COS) over each path (e.g., each source/destination node pair) such that the sum of all the minimum bandwidths does not exceed the bandwidth of any fabric link along the path. For example, referring to FIG. 2, it might be specified that boards 202, 204, and 208 can only transmit packets at 1.3 Gb/s to board 206. Because the sum of these bandwidths is less than the bandwidth of board 206's input link (i.e., 4 Gb/s), congestion at the fabric switch 210 should not occur if these bandwidths are not exceeded. Thus, if the rate-based shaping for all source nodes is set to the guaranteed minimum bandwidth level, no congestion should occur. In one embodiment, the guaranteed minimum bandwidth levels are sized to accommodate all real-time and control traffic, as well as the assured bandwidth levels within the managed traffic class.

In many applications, however, it will be desirable for certain traffic classes to exceed their guaranteed minimum bandwidth level. This will often be true for managed and best effort traffic. Thus, in one embodiment the rates for the managed and best effort traffic classes are allowed to exceed their guaranteed minimum bandwidth levels by some specified factor (e.g., 1.5×, 2×, 3×, or the like), which will be referred to as the maximum bandwidth level of shaping. Since the sum of all the respective maximum bandwidth levels may exceed the total bandwidth of a fabric link, this can lead to congestion.

In one embodiment, the managed and best effort traffic classes are allowed to have maximum bandwidth levels that are significantly more than the guaranteed minimum bandwidth level of shaping, while the real-time and control traffic classes have maximum bandwidth levels of shaping that are substantially the same as their respective guaranteed minimum bandwidth levels of shaping (e.g., the shaping level remains constant at the guaranteed minimum bandwidth level). This scheme allows some congestion to occur at the lower priority traffic classes (e.g., managed and best effort traffic), while preventing congestion at the higher priority traffic classes (e.g., real-time and control traffic).

If congestion is detected along a given path, a BECN is sent from the destination node back to the source node(s) with instructions to slow down traffic along the affected path. In one embodiment, when a source node receives the BECN, it slows down to the guaranteed minimum bandwidth level of shaping until the congestion is alleviated and/or a predefined period of time has elapsed. It will be appreciated that in other embodiments, any of a variety of other possible methods for adjusting the level of shaping between different levels (e.g., between a guaranteed minimum bandwidth level of shaping and a guaranteed maximum bandwidth level of shaping) could be used. Some of these possibilities include:
A simple two-level shaping method with a separate BECN for each level. This is similar to the use of transmitter-on/transmitter-off (XON/XOFF) signals, except instead of signaling traffic to turn on or off completely (which is another potential embodiment), the traffic is signaled to speed up or slow down.
A two-level shaping method that gradually increases the bandwidth from the minimum toward the maximum level, but quickly decreases back to (or towards) the minimum level when a BECN is received. In this case, only a single type of BECN is needed (e.g., slow down). In other words, the shaping rates are automatically and gradually raised beginning some predefined time after the “slow down” BECN is received. This is conceptually similar to TCP.
A two-level shaping method that gradually increases the bandwidth from the minimum towards the maximum level when a “speed up” BECN is received, but rapidly decreases back to the guaranteed minimum bandwidth level when a “slow down” BECN is received. This is similar to the simple two-level shaping method described above, except that the reaction to the “speed up” BECN message is gradual.
Methods that define many different levels of shaping between a minimum and a maximum, potentially with separate latency thresholds and BECN message types associated with each (i.e., speed control with fine adjustments).

Thus it will be appreciated that any suitable level-shaping approach (or none at all) could be used in a particular application.

In some embodiments, the congestion management scheme can allow for the possibility of dropping packets; however, in some embodiments this may be limited to specific traffic classes (e.g., best efforts traffic). For example, in one embodiment packet dropping is not used with real-time traffic, since real time traffic often lacks reliability protocols. Similarly, in one embodiment packet dropping is not used with control traffic, since the relatively low latency requirements associated with control traffic typically will not tolerate frequently dropped packets, even though reliability protocols may be used to recover any packets that are dropped.

In one embodiment, packet dropping is also not used with managed traffic. Managed traffic generally contains some assured bandwidth levels for specific user connections. For example, a service level agreement may assure 100 megabits per second, but allow more bandwidth if it is available. In this case, packets may be dropped only if the user exceeds his or her assured bandwidth level. However, fabric switch devices may be unable to distinguish assured bandwidth level packets from excess bandwidth packets. Thus, a congestion management scheme that frequently drops packets in the fabric switch devices may not be useful for the managed traffic class.

Best effort traffic, on the other hand, is usually implemented using a reliability protocol at its endpoints (e.g., TCP). Thus, a congestion management mechanism that drops packets will often work well for best effort traffic, since the dropped packets will simply be re-sent. However, it will often be preferable to drop packets at the relatively large output queue of the destination node (e.g., the system egress point) rather than at the relatively small queue of the fabric switch device. Thus, in one embodiment the fabric switch device drops packets sparingly (if at all).

In embodiments that use rate-based shaping, the ability to drop packets in the fabric switch devices may affect the maximum bandwidth level of shaping. Even if the BECN messages are sent at a higher priority (e.g., as control traffic), they may still be relatively slow. Thus, if the maximum bandwidth level of shaping is too high, it is possible that the fabric switch device's queues may become full before the source node(s) respond to the BECN.

However, for a given system fabric, the statistical probability that a number of source nodes may gang up on a destination node may be relatively small, and thus the fabric switch devices will only rarely need to drop packets. Thus, it will often be acceptable to increase the maximum bandwidth level of shaping to a point where packets are occasionally dropped in the fabric switch devices in order to gain more usable fabric bandwidth for the lower priority traffic classes.

A variety of rate/bandwidth shaping mechanisms have been described. Those skilled in the art will recognize that the optimal shaping mechanism will depend on the application, and can be readily determined through modeling, simulation, or the like.

As previously indicated, the Network Timing Protocol (NTP) can be used to synchronize the time base at each node in a system fabric. NTP has been used to achieve a common time base across the Internet. In particular, there are implementations of NTP that guarantee 10 ms accuracy across the United States. This is done by sending repetitive packets between endpoints, and using a special algorithm to accurately converge the time at the endpoints. Since the delivery latency over the Internet can be quite large and unpredictable (e.g., milliseconds to several seconds), 10 ms accuracy represents two to three orders of magnitude more accuracy than the delivery latency. By contrast, the delivery latency for a system fabric is often less than 1 ms. Thus, applying the same scaling factor, accuracy in the 1 μs to 10 μs range should be possible.

In one embodiment, the basic timing protocol involves sending messages at regular intervals from a timing client to a timing server and back. Four time-stamps (TS) are appended to this round-trip message. Specifically:

| | |
|---|---|
| TS1 | Appended by the client when it sends the message to the server |
| TS2 | Appended by the server when it receives the message |
| TS3 | Appended by the server when it sends the message back to |
| | the client |
| TS4 | Appended by the client when it receives the message |

These four time-stamps are then used by the timing algorithm, which calculates the round-trip delay. In one embodiment the round-trip delay is computed as: (TS4−TS1)−(TS3−TS2). This corresponds to the time it takes for a message to travel to the timing server and back, minus the time it takes for the server to turn the message around. Note that in the context of a system fabric, one of the nodes and/or the control plane can be treated as the server, and the other nodes as the clients.

In one embodiment, the timing algorithm performs a statistical minimum function. For example, the algorithm might throw away all samples that are significantly higher than the minimum round-trip delay. The round-trip delay from these statistical minimum samples is then divided by two to estimate the one-way delay, and the client's time base is adjusted accordingly using a sliding window average type function.

Although NTP does not explicitly account for asymmetric delays (e.g., forward and reverse paths having different queuing delays, as might occur if the forward path is always congested and the reverse path is not), in one embodiment the fabric timing algorithm can account for this by sending a sufficient number of samples and using a statistical minimum function. Although high queuing delays may be quite frequent, the probability of constant, high queuing delays will be low. In other words, there is a high probability that a given queue will at least occasionally be empty. Thus, by taking the statistical minimum round-trip delay, asymmetric queuing delays can be filtered out. In one embodiment, the timing messages used to synchronize the nodes can be sent as control traffic so that they encounter little if any congestion.

In one embodiment, the system fabric time-stamp is 16-bits long and is applied to system fabric frames (not the individual system fabric packlets within a frame). This is because the system fabric time-stamp relates to the time at which the data leaves the source node (e.g., as determined by the output scheduler). Since system fabrics typically perform system fabric multiplexing and output scheduling at the same time, the time-stamp is, in some embodiments, appended to the system fabric frame (e.g., at the system fabric multiplexing stage).

In one embodiment the system fabric frame time-stamp is expressed in units of one microsecond (1 μs). For example, a time-stamp of 3 represents 3 μs. If the time-stamp is 16 bits long, it will wrap around every 65.5 ms (i.e., 2¹⁶ μs). In some embodiments, the time-base of each node will be a higher number of bits (e.g. 32 or 64 bits); however, a 16-bit count of microseconds will still be relatively easy to calculate from the time-base (e.g. by pulling out the appropriate 16 bits).

Thus, a variety of systems and methods have been described for managing congestion on a system fabric or network through the use of time stamps. It should be appreciated that there are many other advantages for an accurate common time-base across nodes, including event logging (e.g., logging errors, new service requests, etc.), debugging (e.g., determining a sequence of events across nodes to help find a root cause), and/or the like. In addition, although the term packet has, at times, been used in the above description to refer to an Internet protocol (IP) packet encapsulating a TCP segment, a packet may also, or alternatively, be a frame, a fragment, an ATM cell, and so forth, depending on the network technology being used. Moreover, although several examples are provided in the context of a locally administered system fabric, it will be appreciated that the same principles can be readily applied in other contexts as well, such as a distributed fabric or a wide-area network. Thus, while several embodiments are described and illustrated herein, it will be appreciated that they are merely illustrative. Other embodiments are within the scope of the following claims.

1. A method comprising:
applying a time-stamp to a packet at a first node;
transmitting the packet from the first node to a second node;
at the second node, using the time-stamp to calculate a measurement of an amount of time taken for the packet to reach the second node; and
if the measurement is greater than a predefined amount,
sending a notification to the first node; and
in response to receiving the notification at the first node, reducing a rate at which at least some packets are transmitted from the first node to the second node.

2. The method of claim 1, in which the notification is sent at a different priority level from the packet.

3. The method of claim 2, in which the packet comprises best effort traffic, and in which the notification comprises control traffic.

4. The method of claim 1, further comprising:
at the first node, waiting a predefined period of time following receipt of the notification, then increasing the rate at which at least some packets are transmitted from the first node to the second node.

5. The method of claim 1, further comprising:
prior to applying the time-stamp to the packet at the first node, synchronizing a measure of time maintained by the first node and the second node.

6. The method of claim 1, in which the first node and the second node form part of a system fabric.

7. The method of claim 6, in which the system fabric uses rate-based shaping to control the rate at which packets are transmitted from the first node to other nodes in the system fabric.

8. The method of claim 7, in which reducing the rate at which at least some packets are transmitted from the first node to the second node comprises:
reducing a rate at which packets in a first class of service are transmitted from the first node to the second node from a first rate to a second rate.

9. The method of claim 8, in which the first rate comprises a maximum bandwidth level of shaping, and in which the second rate comprises a guaranteed minimum bandwidth level of shaping.

10. The method of claim 8, in which the first class of service comprises best effort traffic.

11. The method of claim 8, further comprising:
reducing a rate at which packets in a second class of service are transmitted from the first node to the second node from a third rate to a fourth rate.

12. The method of claim 8, further comprising:
leaving unchanged a rate at which packets in a second class of service are transmitted from the first node to the second node.

13. The method of claim 1, in which the second node comprises a node at a network location remote from the first node.

14. The method of claim 1, in which the packet is selected from the group consisting of TCP/IP packet, Ethernet frame, and ATM cell.

15. A system fabric comprising:
a plurality of nodes, each node being operable to:
calculate, using a packet time-stamp, an amount of time taken by a packet to arrive from another node;
send notifications to other nodes, the notifications indicating that packets received from the other nodes took more than a predefined amount of time to arrive; and
a switch for directing packets between the nodes.

16. The system of claim 15, in which each node is further operable to:
send packets to other nodes in the fabric, the packets including a time-stamp;
receive notifications from other nodes in the fabric, the notifications indicating that packets sent to the other nodes took more than a predefined amount of time to arrive; and
reduce a rate at which at least some packets are sent to nodes from which a notification has been received.

17. The system of claim 16, in which the nodes are operable to send the notifications at a higher priority level than the packets.

18. The system of claim 16, in which each node is operable to reduce a rate at which packets in a first class of service are sent to nodes from which a notification has been received.

19. A computer program package embodied on a computer readable medium, the computer program package including instructions that, when executed by a processor, cause the processor to perform actions comprising:
applying a time-stamp to a packet;
transmitting the packet to a destination node;
receiving a notification from the destination node, the notification having been sent by the destination node in response to receiving the packet and evaluating the time stamp; and
in response to receiving the notification, at least temporarily reducing a rate of transmission of at least some packets to the destination node.

20. The computer program package of claim 19, further including instructions that, when executed by the processor, cause the processor to perform actions comprising:
receiving a packet from a source node, the packet having a time-stamp associated therewith;
comparing the time-stamp to a locally maintained time measurement; and
if the time-stamp and the locally maintained time measurement differ by more than a predefined amount, sending a notification to the source node.

21. The computer program package of claim 19, in which the notification is associated with a different class of service from the packet.

22. The computer program package of claim 19, in which at least temporarily reducing the rate of transmission of at least some packets to the destination node comprises at least temporarily stopping transmission of additional packets in a first class of service to the destination node.

23. The computer program package of claim 19, further including instructions that, when executed by the processor, cause the processor to perform actions comprising:
receiving a second notification from the destination node; and
responsive to receiving the second notification, transmitting at least some additional packets to the destination node at an increased rate.

24. A computer program package embodied on a computer readable medium, the computer program package including instructions that, when executed by a processor, cause the processor to perform actions comprising:
receiving a packet from a first node, the packet having a time-stamp associated therewith;
comparing the time-stamp to a current time; and
if the time-stamp and the current time differ by more than a predefined amount, sending a notification to the first node, the notification being operable to cause the first node to suspend or slow a rate of transmission of at least some additional packets.

25. The computer program package of claim 24, in which the notification is associated with a different class of service from the packet.

26. The computer program package of claim 24, further including instructions that, when executed by the processor, cause the processor to perform actions comprising:
sending a second notification to the first node, the second notification being operable to cause the first node to increase the rate of transmission of at least some additional packets.

27. The computer program package of claim 24, further including instructions that, when executed by the processor, cause the processor to perform actions comprising:
sending a second notification to the first node, the second notification being operable to cause the first node to further decrease the rate of transmission of at least some additional packets associated with a predefined class of service.

28. A system comprising:
a first system fabric comprising:
a first node, the first node including software that, when executed by a processor on the first node, causes the first node to perform actions comprising:
applying a time-stamp to a packet;
transmitting the packet over a network to a second node on a second system fabric;
receiving a notification from the second node; and
in response to receiving the notification, slowing a rate of transmission of at least some additional packets to the second node;
a second system fabric comprising:
a second node, the second node including software that, when executed by a processor on the second node, causes the second node to perform actions comprising:
receiving a packet from the first node, the packet having a time-stamp associated therewith;
comparing the time-stamp to a current time; and
if the time-stamp and the current time differ by more than a predefined amount, sending a notification to the first node, the notification being operable to cause the first node to slow a rate of transmission of at least some additional packets to the second node; and
a network for communicatively connecting the first system fabric and the second system fabric.

29. The system of claim 28, in which slowing the rate of transmission of at least some additional packets to the second node comprises slowing a rate of transmission of packets belonging to a first class of service.

30. The system of claim 28, in which the first node further includes software that, when executed by a processor on the first node, causes the first node to perform actions comprising:
receiving a packet from the second node, the packet having a time-stamp associated therewith;
comparing the time-stamp to a current time; and
if the time-stamp and the current time differ by more than a predefined amount, sending a notification to the second node, the notification being operable to cause the second node to slow a rate of transmission of at least some additional packets to the first node;
and in which the second node further includes software that, when executed by a processor on the second node, causes the second node to perform actions comprising:
applying a time-stamp to a packet;
transmitting the packet over the network to the first node;
receiving a notification from the first node; and
in response to receiving the notification, slowing a rate of transmission of at least some additional packets to the first node.
